(19) United States
(12) Patent Application Publication
(10) Pub. No.: US 2023/0118708 A1
(43) Pub. Date: Apr. 20, 2023

(54) STRENGTH-TYPE INTELLIGENT FITNESS EQUIPMENT AND COMPENSATION METHODS FOR OUTPUT FORCE OF THE STRENGTH-TYPE INTELLIGENT FITNESS EQUIPMENT

(71) Applicant: CHENGDU FIT-FUTURE TECHNOLOGY CO., LTD., Chengdu (CN)

(72) Inventors: Bowen ZHANG, Chengdu (CN); Weitao XI, Chengdu (CN); Qiang FU, Chengdu (CN); Tianguang TANG, Chengdu (CN); Yuhan TANG, Chengdu (CN)

(73) Assignee: CHENGDU FIT-FUTURE TECHNOLOGY CO., LTD., Chengdu (CN)

(21) Appl. No.: 18/045,513

(22) Filed: Oct. 11, 2022

(30) Foreign Application Priority Data
Oct. 14, 2021 (CN) 202111198951.0

(51) Int. Cl. A63B 24/00; G05D 15/01; A63B 21/00

(52) U.S. Cl. CPC A63B 24/0087; G05D 15/01; A63B 21/154; A63B 21/153; A63B 24/0062; A63B 2024/0093; A63B 2220/51; A63B 2220/833; A63B 2225/02

(57) ABSTRACT

The disclosure discloses a compensation method for output force of a strength-type intelligent fitness equipment, which relates to the field of intelligent fitness. The method comprises: obtaining the actual output force of the strength-type intelligent fitness equipment; obtaining the friction force of strength-type intelligent fitness equipment; compensating the output force of the strength-type intelligent fitness equipment based on the actual output force and the friction force.

### CROSS-REFERENCE TO RELATED DISCLOSURES

This application claims priority to Chinese Patent Application No. 202111198951.0, filed on Oct. 14, 2021, the entire contents of which are hereby incorporated by reference.

### TECHNICAL FIELD

The disclosure relates to the field of intelligent fitness, in particular to a compensation method for output force of strength-type intelligent fitness equipment.

### BACKGROUND

The working principle of the strength-type intelligent fitness equipment is that: the strength-type intelligent fitness equipment includes a motor, a differential, a support arm, a pull rope and a corresponding controller, circuits and accessories, and a belt is connected between the output shaft motor and the differential, one end of the pull rope is connected to the differential, and the other end of the pull rope is connected to the corresponding pull ring or other fitness accessories after moving along the support arm. The pull rope drives the motor to move through the differential and the belt. When the motor is energized, the output torque (i.e., the resistance) is generated. The user needs to overcome the output torque of the motor when pulling the pull rope, thereby achieving the purpose of strength training for the user.

The output force of a strength-type intelligent fitness equipment needs to rely on transmission parts, but the transmission parts will bring friction, so the set force is not be equal to the actual output force. In addition, when the user uses the strength-type intelligent fitness equipment to perform resistance exercise, there are two strokes: pull-out and pull-in. During the pull-out process, the actual output force is equal to the output force of the motor plus friction force, and during the pull-in process, the actual output force is equal to the output force of the motor minus the friction force. If the same force is output when pulling out and pulling in, the actual output force will be different due to the inconsistent direction of the friction force.

### SUMMARY

Various embodiments of the present disclosure provide a compensation method for the output force of the strength-type intelligent fitness equipment. The set force of the strength-type intelligent fitness equipment is equal to the actual output force through compensation method.

The present disclosure provides a compensation method for output force of strength-type intelligent fitness equipment, the method comprising: obtaining an actual output of strength-type intelligent fitness equipment; obtaining the frictional force of the strength-type intelligent fitness equipment; and compensating the output force of the strength-type intelligent fitness equipment based on the actual output force and the friction force.

In some embodiments, the method is obtaining the actual output force and friction force of the strength-type intelligent fitness equipment by measuring, compensating the output force of the strength-type intelligent fitness equipment based on the actual output force and the friction force, causing that the set force of the strength-type intelligent fitness equipment is equal to the actual output force.

In some embodiments, the method further includes: determining a first direction of the output force of the strength-type intelligent fitness equipment; and compensating the output force of the strength-type intelligent fitness equipment based on the first direction, actual output force, and the friction force.

Since the friction force of the strength-type intelligent fitness equipment is different in different motion directions, in order to achieve accurate compensation for output force, it is necessary to first determine a direction of the output force of the strength-type intelligent fitness equipment, and then perform the compensation for the output force.

In some embodiments, this method obtains the actual output force through a calibration.

Specific calibration includes: connecting the tension detection device to the strength-type intelligent fitness equipment; obtaining the actual tension of the strength-type intelligent fitness equipment by turning on the tension detection device; obtaining the tension deviation based on the target tension of the strength-type intelligent fitness equipment and the actual tension; calibrating the strength-type intelligent fitness equipment based on the tension deviation.

In some embodiments, the calibration method is: connecting the tension detection device with the strength-type intelligent fitness equipment, detecting the output force of the strength-type intelligent fitness equipment by the strength-type intelligent fitness equipment, and obtaining the tension deviation based on the target tension and the actual tension of the strength-type intelligent fitness equipment; calibrating the strength-type intelligent fitness equipment by using the obtained tension deviation, so that the output force of the strength-type intelligent fitness equipment after calibration is accurate.

In some embodiments, the tension detection device is a tension table, and the tension sensor of the tension detection device is connected to the pull rope of the strength-type intelligent fitness equipment. The corresponding tension may be generated by using the tension table to pull the pull rope of the strength-type intelligent fitness equipment, and the tension may be measured by the tension sensor.

In some embodiments, the pulling rope is connected to the tension sensor after bypassing around the fixed pulley. By setting the fixed pulley, the direction of the acting force may be changed, which facilitates the calibration in practice.

In some embodiments, the detection process of the tension detection device is that the tension sensor carries the pull rope to perform a round-trip movement at a constant speed. The uniform movement facilitates the stability of the output force of the strength-type intelligent fitness equipment, which facilitates the accuracy of the final calibration result.

In some embodiments, the tension sensor carries the pull rope to perform N groups of round-trip movements, each group including 2 round-trip movements. The tension of the tension table in each group of round-trip movements is constant. The purpose of performing a plurality of groups of round-trip movement is to obtain more data, reduce the risk of incorrect data, and ensure the accuracy of calibration. The purpose of performing the round-trip movement is that the output force in different directions is different. In order to achieve accurate calibration, it is necessary to perform a round-trip movement, and the corresponding output force is calibrated through the round-trip movement. The tension of the tension table in each group of round-trip movement is constant to obtain stable output force data.

In some embodiments, the tension of the tension table corresponding to any two groups of the round-trip movements are different. The purpose of this design is to obtain output force data of different sizes, and finally calculate the accurate output force of the strength-type intelligent fitness equipment through these data to ensure the final accuracy.

In some embodiments, the tension of the tension table corresponding to the first group of the round-trip movement to the Nth group the round-trip movement progressively increases.

In some embodiments, the method further comprises sampling the tension of the tension detection device at a preset frequency.

In some embodiments, the unilateral distance of the round-trip movement is S, and the actual tension of the strength-type intelligent fitness equipment is calculated by taking the tension data of a stroke of 1/4S to 3/4S.

In some embodiments, the actual tension of the strength-type intelligent fitness equipment is Fₒᵤₜ when the pull rope is pulled out, and the actual tension of the strength-type intelligent fitness equipment is Fᵢₙ when the pull rope is pulled in, the output force of the strength-type intelligent fitness equipment is Fₘₒₜₒᵣ, where Fₘₒₜₒᵣ=(Fₒᵤₜ+Fᵢₙ)/2.

In some embodiments, in this compensation method, if the first direction is the pull-out direction, the actual output force is Fᵣₑₐₗ=k₁F_{config}+b₁, the friction force is f=k₂F_{config}+b₂ and the compensated output force of the strength-type intelligent fitness equipment is Fₒᵤₜ=(F_{config}-(b₁+b₂))/(k₁+k₂); if the first direction is the pull-in direction, the actual output force is Fᵣₑₐₗ=k₁F_{config}+b₁, the friction force is f=k₂F_{config}+b₂, and the compensated output force of the strength-type intelligent fitness equipment is Fᵢₙ=(F_{config}−(b₁-b₂))/(k₁-k₂), where k₁, k₂, b₁, and b₂ are all corresponding coefficients. k₁, k₂, b₁ and b₂ are determined by the tension calibration process, which establishes the tension and friction models, and the coefficients k₁, k₂, b₁, and b₂ are the model parameters.

In some embodiments, the direction judgment method in this method is that: if the moving speed of the pull rope of the strength-type intelligent fitness equipment is greater than or equal to a threshold value, the first direction is judged as the pull-out direction; if the moving speed of the pulling rope of the strength-type intelligent fitness equipment is less than the threshold, the first direction is determined as the pull-in direction.

One or more technical solutions provided by the present disclosure have at least the following technical effects or advantages.

The method can compensate the output force of the strength-type intelligent fitness equipment, and the set force of the strength-type intelligent fitness equipment can be equal to the actual output force through the compensation.

This method can calibrate the output force of the strength-type intelligent fitness equipment, the calibration results are accurate, and the compensation results are accurate.

### BRIEF DESCRIPTION OF THE DRAWINGS

The accompanying drawings described herein are used to provide a further understanding of the embodiments of the present invention, and constitute a part of the present disclosure, but do not constitute a limitation to the embodiments of the present disclosure; wherein:

FIG. 1 is a flowchart of the compensation method for output force of a strength-type intelligent fitness equipment;

FIG. 2 is a schematic diagram of the principle of the calibration method of the output force of a strength-type intelligent fitness equipment.

### DETAILED DESCRIPTION

In order to be able to understand the above purposes, features, and advantages of the present disclosure more clearly, the following combines the attachment and specific embodiments further describe the present disclosure in detail. It should be noted that the embodiments of the present disclosure and the features in the embodiments may be combined with each other under the condition that they do not conflict with each other.

In the following description, numerous specific details are set forth in order to provide a thorough understanding of the present disclosure, however, the present disclosure may be practiced in other ways than those described herein. Therefore, the protection scope of the present disclosure is not limited by the specific embodiments disclosed below.

### Embodiment 1

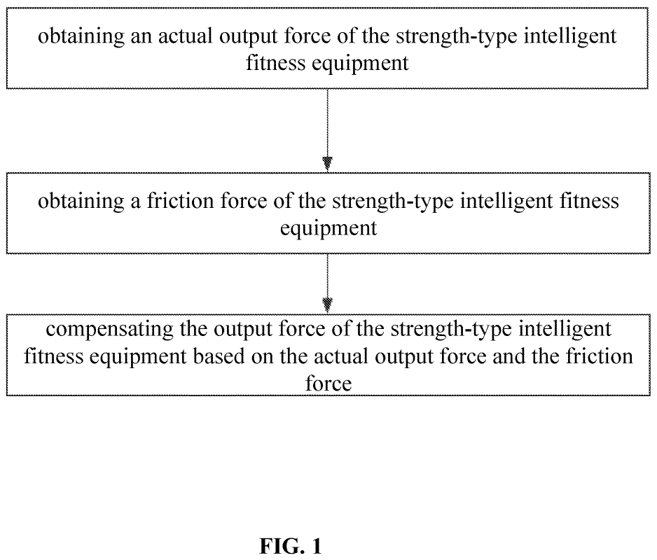

Please refer to FIG. 1, FIG. 1 is a flowchart for the compensation method of output force of a strength-type intelligent fitness equipment, embodiment 1 of the present disclosure provides a compensation method for output force of a strength-type intelligent fitness equipment, the method comprising: obtaining an actual output force of strength-type intelligent fitness equipment; obtaining friction force of strength-type intelligent fitness equipment; compensating the output force of the strength-type intelligent fitness equipment based on the actual output force and the friction force.

The purpose of the compensation for the output force is to ensure that the deviation between the actual output force and the set force during the pull-out and pull-in process meets the given standard through the actual output force and friction force.

In the embodiment of the present disclosure, the method further includes determining a first direction of the output force of the strength-type intelligent fitness equipment; and compensating the output force of the strength-type intelligent fitness equipment based on the first direction, actual output force, and the friction force.

In the tension compensation process, it is necessary to distinguish between the pull-out process and the pull-in process, the compensation force of the pull-out process and the pull-in process is different. Therefore, it is necessary to judge the direction of the stroke and a speed threshold is required. When the speed is lower than the threshold, it is considered as the pull-in process, when the speed is greater than the threshold, it is considered as the pull-out process. The speed is defined as positive when pulling out and the speed is defined as negative when pulling in.

The size of the speed threshold may be flexibly adjusted according to the actual situation, which is not specifically limited in the embodiment of the present disclosure, and the speed threshold is related to the current travel direction.

When the current state is in the pull-out state, the speed threshold is 0.05 m/s (which may avoid too little force in the initial stage of pulling in);

2. When the current state is in the pull-in state, the speed threshold is −0.05 m/s (which may avoid a sense of blockage in the initial stage of pulling out).

In the embodiment of the present disclosure, the specific compensation method is as follows.

Compensation method: assuming that the actual output force model obtained by tension calibration is: Fᵣₑₐₗ=k₁ F_{config}+b₁, where Fᵣₑₐₗ is the output force of the motor, F_{config} is set force, and k₁ and b₁ are coefficients.

The friction force model is f=k₂F_{config}+b₂, where f is the transmission friction force, F_{config} is the setting force, and k₂ and b₂ are the coefficients. Therefore, the compensated setting force is in the pull-out stage: Fₒᵤₜ=(F_{config}−(b₁+b₂))/(k₁+k₂), the compensated setting force is in the pull-in stage: Fᵢₙ=(F_{config}−(b₁-b₂))/(k₁-k₂), and then tension compensation may be achieved.

### Embodiment 2

On the basis of Embodiment 1, Embodiment 2 introduces the calibration method in the first embodiment in detail.

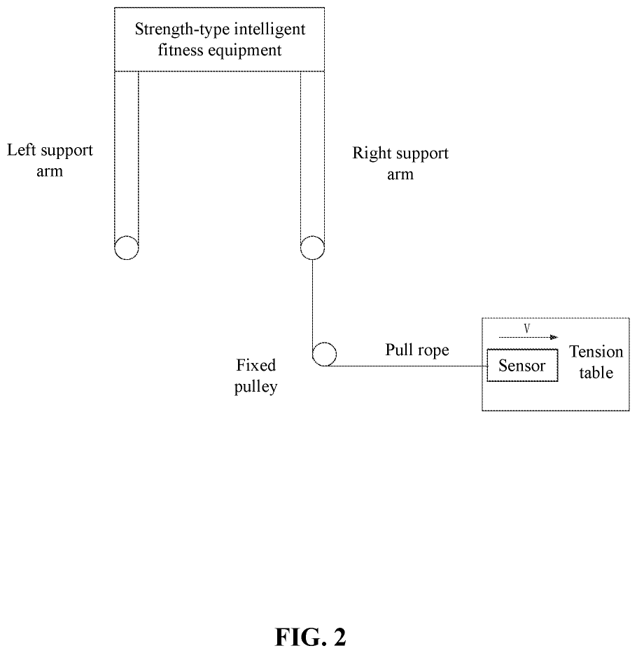

Please refer to FIG. 2, FIG. 2 is a schematic diagram of the principle of the calibration method for output force of a strength-type intelligent fitness equipment. Embodiment 2 of the present disclosure provides a calibration method for the output force of a strength-type intelligent fitness equipment, and the method comprises: connecting the tension detection device to the strength-type intelligent fitness equipment; obtaining the actual tension of the strength-type intelligent fitness equipment by turning on the tension detection device to perform detection; obtaining the tension deviation based on the target tension of the strength-type intelligent fitness equipment and the actual tension; and calibrating the strength-type intelligent fitness equipment based on the tension deviation.

The tension detection device in the embodiment 2 is a tension table, a tension device, or a tension detector. In practical application, the tension detection device may also be other types of tension detection devices, the embodiment of the present disclosure does not limit the specific implementation of the tension detection device.

In the embodiment 2 of the present disclosure, the purpose of calibrating the output force of the strength-type intelligent fitness equipment is that: the strength-type intelligent fitness equipment provides a load to the user through the output force to achieve the purpose of impedance training. There is a deviation between the set force and the actual output force, and the deviation needs to meet certain standards. Therefore, it is necessary to perform calibration for output force and calibration compensation for output force of each device before leaving the factory, so that the deviation meets the corresponding standards. The calibration process is the process of obtaining the actual output force data and establishing the output force model, and the process of correcting the output force through the output force model is called as the compensation process.

The deviation type of output force of strength-type intelligent fitness equipment is divided into two categories.

The deviation of the output force is related to the size of the target force and the pull-out stroke, and the deviation is also different for different machines and different arms of the same machine. It is considered that the deviation is independent of the speed, and the composition of the deviation includes as follows.

The first category is the deviation caused by the structure.

a. The difference between actual average tension of the left and right support arms.

b. The difference between the actual tension strokes of a single support arm (difference between the maximum instantaneous force and the minimum instantaneous force in the process of pulling out or pulling in at a constant speed).

The second category is calibratable deviation.

c. Deviation between the actual average tension of the single support arm and the target pulling force.

Both the pull-out stage and the pull-in stage of the strength-type intelligent fitness equipment need to meet the same tension accuracy requirements: −(0.5+5%F)<delta<0.5+5% F, where F is the set force, delta is the above-mentioned deviation of c, and the two deviation standards of a and b are different from that of c.

The tension detection device is connected to the strength-type intelligent fitness equipment, the output force of the strength-type intelligent fitness equipment is detected through the strength-type intelligent fitness equipment, and the tension deviation is obtained based on the target tension of the strength-type intelligent fitness equipment and the actual tension, the strength-type intelligent fitness equipment is calibrated by using the obtained tension deviation, and the output force of the strength-type intelligent fitness equipment after calibration is accurate.

In the embodiment 2 of the present disclosure, the tension detection device is a tension table, and the tension sensor of the tension detection device is connected to the pull rope of the strength-type intelligent fitness equipment. The corresponding tension may be generated by using the tension table to pull the pull rope of the strength-type intelligent fitness equipment, and the tension may be measured by the tension sensor.

In the embodiment 2 of the present disclosure, the pull rope is connected to the tension sensor after bypassing the fixed pulley. The direction of the acting force may be changed through the fixed pulley, which is convenient for calibration in practice.

In the embodiment 2 of the present disclosure, the detection process of the tension detection device is that the tension sensor carries the pull rope to move back and forth at a constant speed. The uniform movement facilitates the stability of the output force of the strength-type intelligent fitness equipment, which facilitates the accuracy of the final calibration result.

In the embodiment 2 of the present disclosure, the tension sensor carries the pull rope to perform N groups of round-trip movements, and each group includes 2 round-trip movements. The tension of the tension table in each group of round-trip movements is constant. The purpose of performing multiple groups of round-trip movements is to obtain more data, reduce the risk of incorrect data, and ensure the accuracy of calibration. The purpose of performing round-trip movement is that the output force in different directions is different. In order to achieve accurate calibration, it is necessary to perform a round-trip movement, and the corresponding output force is calibrated through the round-trip movement. The tension of the tension table in each group of round-trip movement is constant to obtain stable output force data.

In the embodiment 2 of the present disclosure, the tension of the tension table corresponding to any two groups of the round-trip movement is different. The purpose of this design is to obtain output force data of different sizes, and finally calculate the accurate output force of the strength-type intelligent fitness equipment through these data to ensure the final accuracy.

In the embodiment 2 of the present disclosure, the tension of the tension table corresponding to the first group of round-trip movement to the Nth group of the round-trip movement progressively increases.

In the embodiment 2 of the present disclosure, the method further includes sampling the tension of the tension detection device at a preset frequency.

In the embodiment 2 of the present disclosure, the unilateral distance of the round-trip movement is S, and the actual tension of the strength-type intelligent fitness equipment is calculated by taking the tension data of a stroke of 1/4S to 3/4S.

Specific calibration is as follows.

The tension table is used for tension calibration. When calibrating, the tension sensor of the tension table is connected to the pull rope. The tension table may control the tension sensor to move at a constant speed of 0.2 m/s, and save the data of the tension sensor in real-time at 50 Hz to detect the actual tension of the pull rope at this time, which is compared with the actual tension of the strength-type intelligent fitness equipment to calibrate the tension.

As shown in FIG. 2, a fixed pulley may be used, or a pull rope may be connected directly to the tension sensor.

The calibration steps in the embodiment of the present disclosure are as follows.

From the minimum force to the maximum force, evenly taking four points, such as 3 kg, 10 kg, 30 kg, 50 kg, or taking one point every 20 kg, and setting the set force as the above tension in turn.

1. For setting each tension, controlling the sensor on the tension table to perform round-trip movement twice at a constant speed of 0.2 m/s, with a single stroke of 800 mm, and sampling the tension at a frequency of 50 Hz. The interval between each round-trip movement is 1.5 s, and the speed change interval is 0.5 s.

2. Taking a tension data with a stroke of 200-600 mm.

3. Calculating the difference between the average tension, the maximum tension, and the minimum tension.

4. Repeating steps 2 and 3 on the other support arm.

The principle of calibration in this embodiment is as follows.

Assuming that the actual output tension of the strength-type intelligent fitness equipment is linearly related to the set tension, setting the actual output tension of the motor as Fₘₒₜₒᵣ, the set tension as F_{config}, and the absolute value of friction force is f, letting:

Fₘₒₜₒᵣ=k₁ F_{config}+b₁.

f=k₂F_{config}+b₂.

Assuming that in the pull-out stage, the actual tension is Fₒᵤₜ, and in the pull-in stage, the actual tension is Fᵢₙ, including:

Fₒᵤₜ=Fₘₒₜₒᵣ+f; Fᵢₙ=Fₘₒₜₒᵣ−f.

That is, in the pull-out stage:

F_{config}=(Fₒᵤₜ−(b₁+b₂))/(k₁+k₂).

In the pull-in stage:

F_{config}=(Fᵢₙ−(b₁−b₂))/(k₁−k₂).

When carrying out the tension calibration, the expected configuration tension is calculated according to the actual average tension in the pull-out and recovery stages, and the originally expected tension is replaced to achieve the effect of tension calibration, where k₁, k₂, b, and b₂ are all corresponding coefficients.

Assuming that the absolute value of the friction force in the pull-out and pull-in stages is equal when the tension calibration is not performed, the friction force may be determined according to the difference between the pull-out and pull-in forces: f=(Fₒᵤₜ−Fᵢₙ)/2.

Therefore, the output tension of the motor may be obtained as: Fₘₒₜₒᵣ=Fₒᵤₜ+Fᵢₙ)/2.

The tension table is used for calibration, and the tension table is controlled to pull-out and pull-in at a constant speed, the tension of the pull rope may be monitored in real time through the tension sensor of the tension table, the tension deviation may be obtained by comparing the actual tension and the target tension to perform tension calibration.

Although preferred embodiments of the present disclosure have been described, additional changes and modifications to these embodiments may occur to those skilled in the art once the basic inventive concepts are known. Therefore, the appended claims are intended to be construed to include the preferred embodiment and all changes and modifications that fall within the scope of the present disclosure.

It will be apparent to those skilled in the art that various modifications and variations can be made in the present disclosure without departing from the spirit and scope of the present disclosure. Thus, provided that these modifications and variations of the present disclosure fall within the scope of the claims of the present disclosure and their equivalents, the present disclosure is also intended to include these modifications and variations.

What is claimed is:

1. A compensation method for output force of strength-type intelligent fitness equipment, comprising:
obtaining an actual output force of the strength-type intelligent fitness equipment;
obtaining a friction force of the strength-type intelligent fitness equipment; and
compensating the output force of the strength-type intelligent fitness equipment based on the actual output force and the friction force.

2. The compensation method of claim 1, further comprising:
determining a first direction of the output force of the strength-type intelligent fitness equipment; and
compensating the output force of the strength-type intelligent fitness equipment based on the actual output force, the friction force, and the first direction.

3. The compensation method of claim 2, wherein the actual output force is obtained by calibration.

4. The compensation method of claim 2, wherein the obtaining the actual output force by calibration includes:
connecting a tension detection device to the strength-type intelligent fitness equipment;
obtaining an actual tension of the strength-type intelligent fitness equipment by turning on the tension detection device to perform detection;
obtaining a tension deviation based on a target tension of the strength-type intelligent fitness equipment and the actual tension; and
calibrating the strength-type intelligent fitness equipment based on the tension deviation.

5. The compensation method of claim 2, wherein
if the first direction is a pull-out direction, the actual output force is Fᵣₑₐₗ=k₁F_{config}+b₁, the friction force is f=k₂F_{config}+b₂, and the compensated output force of the strength-type intelligent fitness equipment is Fₚᵤₗₗ₋ₒᵤₜ=(F_{config}−(b₁+b₂))/(k₁+k₂); and
if the first direction is a pull-in direction, the actual output force is Fᵣₑₐₗ=k₁F_{config}+b₁, the friction force is f=k₂F_{config}+b₂, and the compensated output force of the strength-type intelligent fitness equipment is Fₚᵤₗₗ₋ᵢₙ=(F_{config}−(b₁-b₂))/(k₁-k₂), where k₁, k₂, b₁ and b₂ are coefficients.

6. The compensation method of claim 2, wherein
if a moving speed of a pull rope of the strength-type intelligent fitness equipment is greater than or equal to a threshold, the first direction is determined as a pull-out direction; and
if the moving speed of the pull rope of the strength-type intelligent fitness equipment is less than the threshold, the first direction is determined as a pull-in direction.

7. The compensation method of claim 4, wherein the tension detection device is a tension table, and a tension sensor of the tension detection device is connected to a pull rope of the strength-type intelligent fitness equipment.

8. The compensation method of claim 7, wherein the pull rope is connected to the tension sensor after bypassing a fixed pulley.

9. The compensation method of claim 7, wherein a detection process of the tension detection device is that the tension sensor carries the pull rope to perform a round-trip movement at a constant speed.

10. The compensation method of claim 7, wherein the tension sensor carries the pull rope to perform N groups of round-trip movements, each group of round-trip movement includes 2 round-trip movements, and a tension of the tension table in each group of round-trip movement is constant.

11. Strength-type intelligent fitness equipment, comprising:
at least one processor;
and one or more memories coupled to the at least one processor and storing programming instructions for execution by the at least one processor to:
obtain an actual output force of the strength-type intelligent fitness equipment;
obtain a friction force of the strength-type intelligent fitness equipment; and
compensate the output force of the strength-type intelligent fitness equipment based on the actual output force and the friction force.

12. The strength-type intelligent fitness equipment of claim 11, wherein the programming instructions are for execution by the at least one processor to:
determine a first direction of the output force of the strength-type intelligent fitness equipment; and
compensate the output force of the strength-type intelligent fitness equipment based on the actual output force, the friction force, and the first direction.

13. The strength-type intelligent fitness equipment of claim 12, wherein the actual output force is obtained by calibration.

14. The strength-type intelligent fitness equipment of claim 12, wherein the programming instructions are for execution by the at least one processor to:
connect a tension detection device to the strength-type intelligent fitness equipment;
obtain an actual tension of the strength-type intelligent fitness equipment by turning on the tension detection device to perform detection;
obtain a tension deviation based on a target tension of the strength-type intelligent fitness equipment and the actual tension; and
calibrate the strength-type intelligent fitness equipment based on the tension deviation.

15. The strength-type intelligent fitness equipment of claim 12, wherein
if the first direction is a pull-out direction, the actual output force is Fᵣₑₐₗ=k₁F_{config}+b₁, the friction force is f=k₂F_{config}+b₂, and the compensated output force of the strength-type intelligent fitness equipment is Fₚᵤₗₗ₋ₒᵤₜ=(F_{config}−(b₁+b₂))/(k₁+k₂); and
if the first direction is a pull-in direction, the actual output force is Fᵣₑₐₗ=k₁F_{config}+b₁, the friction force is f=k₂F_{config}+b₂, and the compensated output force of the strength-type intelligent fitness equipment is Fₚᵤₗₗ₋ᵢₙ=(F_{config}−1-b₂))/(k₁-k₂), where k₁, k₂, b₁ and b₂ are coefficients.

16. The strength-type intelligent fitness equipment of claim 12, wherein
if a moving speed of a pull rope of the strength-type intelligent fitness equipment is greater than or equal to a threshold, the first direction is determined as a pull-out direction; and
if the moving speed of the pull rope of the strength-type intelligent fitness equipment is less than the threshold, the first direction is determined as a pull-in direction.

17. The strength-type intelligent fitness equipment of claim 14, wherein the tension detection device is a tension table, and a tension sensor of the tension detection device is connected to a pull rope of the strength-type intelligent fitness equipment.

18. The strength-type intelligent fitness equipment of claim 17, wherein the pull rope is connected to the tension sensor after bypassing a fixed pulley.

19. The strength-type intelligent fitness equipment of claim 17, wherein a detection process of the tension detection device is that the tension sensor carries the pull rope to perform a round-trip movement at a constant speed.

20. The strength-type intelligent fitness equipment of claim 17, wherein the tension sensor carries the pull rope to perform N groups of round-trip movements, each group of round-trip movement includes 2 round-trip movements, and a tension of the tension table in each group of round-trip movement is constant.
